(19) United States
(12) Patent Application Publication
(10) Pub. No.: US 2006/0120578 A1
(43) Pub. Date: Jun. 8, 2006

(54) Minutiae matching

(75) Inventor: Will Shatford, Pasadena, CA (US)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(73) Assignee: TRI-D Systems, Inc.

(21) Appl. No.: 11/293,485

(22) Filed: Dec. 2, 2005

Related U.S. Application Data
(60) Provisional application No. 60/632,661, filed on Dec. 2, 2004.

(51) Int. Cl. G06K 9/00

(52) U.S. Cl. 382/125

(57) ABSTRACT

A method for print analysis comprising compiling a list of sample minutiae points from a sample image, assigning a predetermined set of evaluation criteria to each sample minutiae point, performing a first matching process to determine a list of potential matching points residing in a template image, performing a second matching process whereby each potentially matching pair is evaluated in accordance to a second set of predetermined evaluation criteria, and determining if the sample image matches the template image based upon results of the second matching process.

### RELATED APPLICATIONS

The present invention claims priority to U.S. Provisional Application No. 60/632,661 filed on Dec. 2, 2004, which is fully incorporated herein by reference.

### FIELD

The present invention relates generally to the field of fingerprint analysis, and, more specifically, to an apparatus and process of minutiae matching for fingerprint identification or verification.

### BACKGROUND

Fingerprints have been widely used for many years as a means for identification or verification of an individual's identity. For many years, experts in the field of fingerprints would manually compare sample fingerprints to determine if two prints matched each other, which allowed for identification or verification of the person that created the fingerprint. In more recent times, fingerprint recognition has been improved by using computer analysis techniques developed to compare a fingerprint with one or more stored sample fingerprints.

Computer analysis of fingerprints has typically involved comparing a complete fingerprint against one or more known samples. In applications where the objective is to identify an individual from a fingerprint sample, the subject fingerprint sample is typically compared to a large volume of samples taken from many people. The volume of samples are typically stored in a database, and the subject print is compared to each fingerprint in the database to determine if there exists a match between the subject sample and any of the samples in the database. For example, a fingerprint sample obtained at a crime scene might be compared to fingerprints in a database containing fingerprints of individuals with prior criminal histories in an attempt to identify the suspect. In applications where the objective is to verify an individual from a fingerprint sample, the subject fingerprint is typically compared to a smaller number of fingerprint samples. For example, fingerprint verification may be used to allow access to a restricted area. A person's fingerprint is sampled and compared against known fingerprints of that individual. A match would indicate a verification of the individual's identity (i.e., that the individual providing the sample is, in fact, the individual whose fingerprints are contained in the database) and access would be allowed.

In many identification and/or verification processes, a fingerprint pad is typically used to obtain the subject sample. A fingerprint pad is typically a small square sensor, usually one-half inch by one-half inch in size, upon which a person places his or her finger. A single image of the person's complete fingerprint is taken, normally using some form of camera or imaging device. The captured image is typically digitized and stored as a digital image that can be compared to other stored images of fingerprints.

More recently, swipe sensors have been developed to obtain fingerprint samples. A swipe sensor is typically a thin, rectangular shaped device measuring approximately one-half inch by one-sixteenth inch. The swipe sensor obtains a number of small images, or snapshots, as a finger is swiped past the sensor. A complete fingerprint image is obtaining by processing these snapshots to form a composite image. The compiling of the smaller images into a complete fingerprint is typically referred to as “stitching” the images.

The developments in swipe sensors have facilitated using fingerprint technology in a variety applications. Recently, fingerprint techniques have been applied to smaller devices, such as smart cards. Processing fingerprints using a swipe sensor, however, typically requires extensive computing resources. Powerful microprocessors, significant amounts of memory, and a relatively long processing time have typically been required to adequately stitch the snapshots into complete images and compare the sampled images with known templates.

### SUMMARY

A method is provided for print analysis comprising compiling a list of sample minutiae points from a sample image, assigning a predetermined set of evaluation criteria to each sample minutiae point, performing a first matching process to determine a list of potential matching points residing in a template image, performing a second matching process whereby each potentially matching pair is evaluated in accordance to a second set of predetermined evaluation criteria, and determining if the sample image matches the template image based upon results of the second matching process.

Additional objects, advantages, and novel features of the invention will be set forth in part in the description, examples, and figures which follow, all of which are intended to be for illustrative purposes only, and not intended in any way to limit the invention, and in part will become apparent those skilled in the art on examination of the following, or may be learned by practice of the invention.

### BRIEF DESCRIPTION OF THE DRAWINGS

For the purpose of illustrating the invention, there is shown in the drawings one exemplary implementation; however, it is understood that this invention is not limited to the precise arrangements and instrumentalities shown.

FIG. 1 is a flow chart illustrating the steps involved in a minutiae matching process in accordance with an exemplary embodiment of the present invention.

FIG. 2 is a flow chart illustrating the steps involved in the minutiae point classification in accordance with an exemplary embodiment of the present invention.

FIG. 3 is a flow chart illustrating the steps involved in the process of identifying potentially matching pairs in accordance with an exemplary embodiment of the present invention.

FIG. 4 is a flow chart illustrating the steps involved in the actual matching processes in accordance with an exemplary embodiment of the present invention.

FIG. 5 is a flow chart illustrating the steps involved in a minutiae matching process in accordance with a second exemplary embodiment of the present invention.

FIG. 6 is a diagram illustrating the classification characteristics of a potentially matching pair of minutiae points in accordance with an exemplary embodiment of the present invention.

### DETAILED DESCRIPTION

Overview

The comparison of a subject fingerprint with one or more sample fingerprint typically involves identifying a plurality of minutiae points in the sample fingerprint and comparing these points to similarly identified points found in the template print. Minutia points are details contained within a fingerprint. Typically, minutiae points comprises points where ridge lines terminate (end minutiae) or divide (bifurcation minutiae).

Minutiae matching algorithms have been developed to compare minutiae points of fingerprints to determine whether a sample print is a match to a template print. These algorithms are typically contained in an application that is run on a computer (e.g., desktop computer, laptop computer). Such applications typically require a large volume of overhead (e.g., memory, hardware, processing resources) to execute. As a result of the high volume of data that is stored and manipulated in a minutiae matching process, a significant amount of memory and processing power is typically needed.

Recent developments in fingerprint sensors such as swipe sensors have increased the popularity of using fingerprint sensors on smaller, less powerful devices (e.g., smartcards). One drawback to using minutiae matching algorithms with such devices is that often the amount of memory and/or processing power is not available on the smart card. In cases where sufficient memory exists, the minutiae matching application often uses the majority available and thus the card is unable to use other applications simultaneously. A need exists for a minutiae matching technique that can be performed using less powerful processors and that requires a smaller amount of memory. Such a technique would enable further developments in areas where fingerprint matching is performed without immediate access to higher power computing devices.

Minutiae Matching Using Reduced Memory

Typical fingerprint matching techniques rely on extracting and identifying many features of a fingerprint. These features include termination or end minutia (i.e., the point at which a ridge line ends) and bifurcation minutiae (the point at which a ridge line divides into two or more lines). The exemplary embodiment of the present invention shall be discussed with reference to these two types of minutiae. It would, however, be apparent to one of skill in the art that other types of fingerprint minutiae can also be used. Additionally, while the exemplary embodiment is discussed with reference solely to fingerprints, it should be noted that exemplary embodiment can be applied to all types of prints, including thumbprints, toe prints, palm prints, etc.

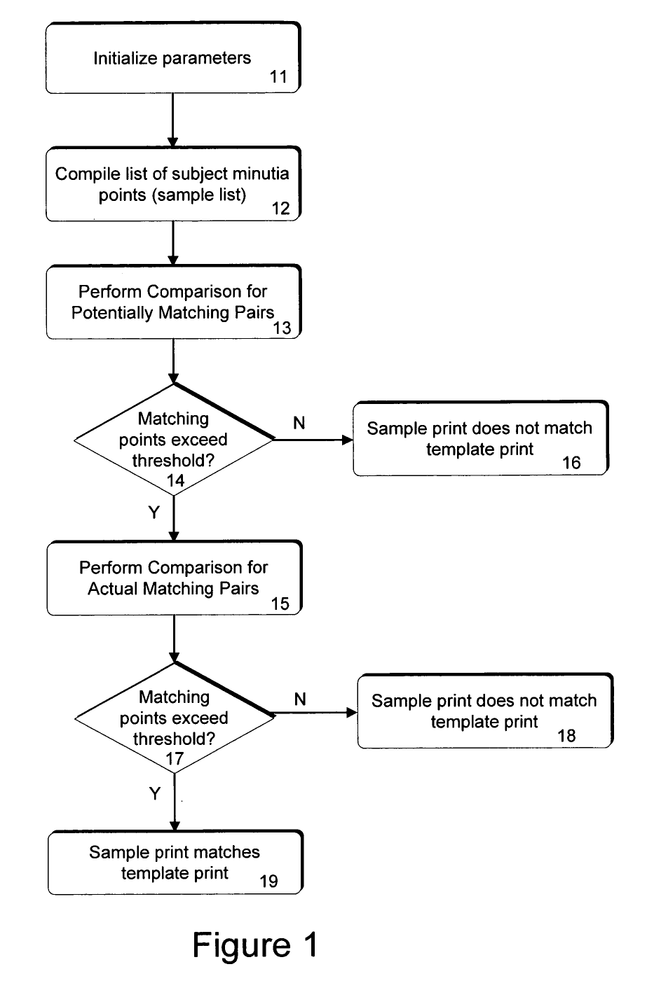

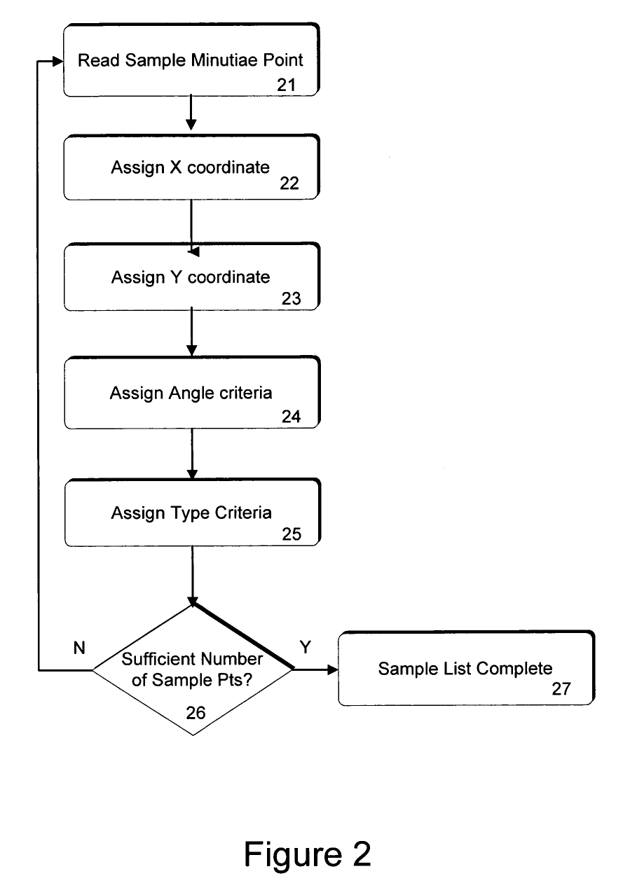

In an exemplary embodiment, the minutiae matching technique involves evaluating a minutiae points from a sample print against a selected number of minutiae points contained in a template print. By reducing the number of comparison points, less memory and less processing power is required. The basic steps involved in a minutiae matching technique in accordance with an exemplary embodiment of the present invention are shown in FIG. 1. Each step is described in further detail below with reference to FIGS. 2-4.

Referring to FIG. 1, a flow chart is shown illustrating the method in accordance with an exemplary embodiment. An initialization step (11) is performed whereby the tolerances that will be used to compare minutiae points from a user's finger (hereinafter referred to as the “sample print”) to minutiae points from an archived fingerprint (hereinafter referred to as the “template print”) are defined. For example, a tolerance range for the geographic location of the minutiae point within a print image can be predetermined. Geographic location of a minutiae point within a print image is typically specified using an X coordinate to represent the horizontal distance from a fixed zero point (e.g., the lower left-hand corner of the sensor used to obtain the image) and a Y coordinate to represent the vertical distance from the fixed zero point. These distances are typically measured as a number of pixels. The tolerance that is used to compare points taken from within a fingerprint image is therefore typically measured as number of pixels. For example, a typical tolerance for the X direction might be +/−64 pixels for a 500 dots per inch (dpi) image and a typical tolerance for the Y direction might be +/−128 pixels for a 500 dpi image. Normally, the tolerance in the Y direction used for comparison purposes is greater than the tolerance in the X direction. This allows for greater positioning error when a swipe sensor is used. Typically, a user will align his or her finger with a fairly high degree of precision in the X direction simply by centering the finger over the sensor. However, the point at which the swipe sensor begins to read the fingerprint in the Y direction tends to vary slightly more because it is subject to variance caused by where the user places his finger to begin the swiping process. Tolerances for any other characteristics that will be used to compare the points from the subject print to the points from the template print are also defined.

After configuring the matching tolerances, a list of minutiae points from the subject print is compiled (12), referred to herein as the sample list. The sample list can typically be obtained by reading a minutiae point from a fingerprint processor, which typically stores a series of points read from a sensor.

Each minutiae point can be classified by a series of characteristics, which are typically stored in a matrix format. Referring to FIG. 2, the steps involved in the classification process of the exemplary embodiment are shown. In the exemplary embodiment, each point is assigned a set of geographic coordinates based upon the geographic location of the point within the fingerprint. A coordinate can be assigned to identify the horizontal location within a print image, referred to as the X coordinate (22), and a coordinate can be assigned to represent the vertical location within a print image, referred to as the Y coordinate. An angle criteria is assigned to each minutiae point (24). The angle criteria is a number, typically measured in degrees, that is representative of the general orientation of the ridge lines in the vicinity of the minutiae point. Various techniques can be used to calculate the angle criteria, although typically a measurement of the ridge lines within a small distance (e.g., 8 pixels at 500 DPI) of the minutiae point are averaged to obtain the angle measurement. Additionally, a type is assigned to each minutia point to differentiate the various types of minutiae (25). In the exemplary embodiment, end type minutiae are assigned an identifier (e.g., type 1) and bifurcation minutiae are assigned a different identifier (e.g., type 2).

After storing the characteristics associated with a sample point, a determination is made as to whether the sample list contains sufficient points to perform the matching process (26). This typically involves counting the points in the sample list until the number of points exceeds a predetermined number. The predetermined number is typically configurable by the user in accordance with the accuracy required for a particular application. If the sample list does not contain a sufficient number of points, the process of obtaining a point from the processor and assigning characteristics for comparison is repeated. Once the number of points in the sample list exceeds the predetermined number, the sample list is complete (27).

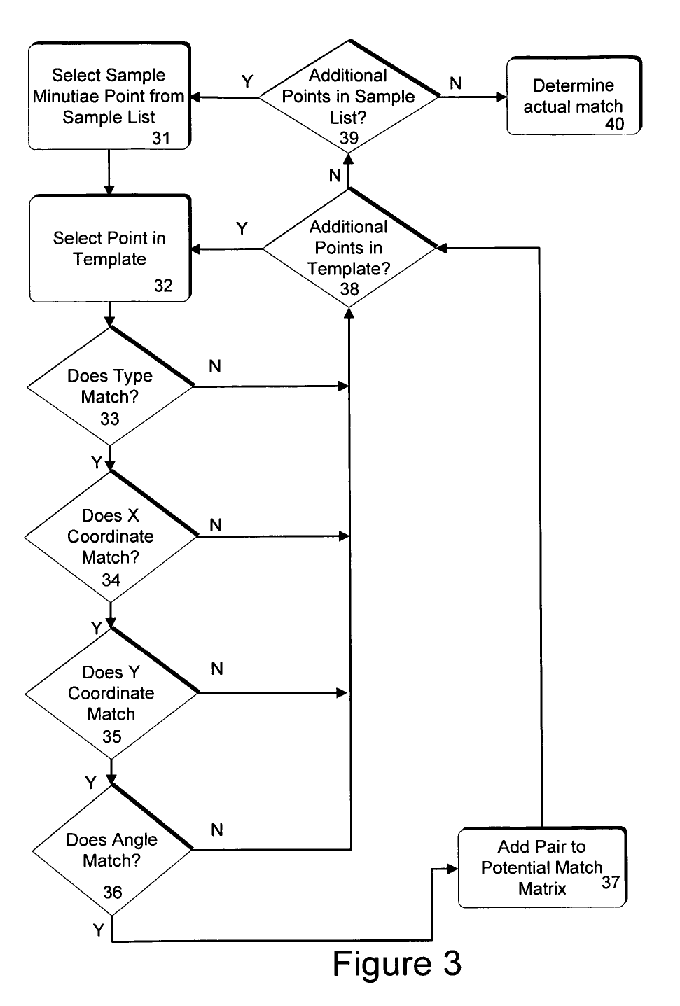

Following the establishment of the matching parameters and the identification of the minutiae characteristics, a comparison process can be performed to determine if a minutiae point from the sample list is a potential match to a minutiae point in the template (Step 13 of FIG. 1). Referring to FIG. 3, a detailed view of the comparison process for identifying potentially matching minutiae point pairs is shown. A series of comparisons are performed to reduce the number of possible matching minutiae. In the exemplary embodiment, a first sample minutiae point can be selected from the sample list (31). A first template point can be selected from the template image for comparison from the template with the first sample point (32). A comparison of minutiae type can be performed to determine if the sample point can match a first point selected from the template image (33). If the type does not match, the comparison process does not need to proceed further. A check can be performed to determine if additional minutiae points remain in the template image (38). If so, the next minutiae point in the template can be selected (32) and the comparison process is repeated. If not, a check can be performed to determine if additional points remain on the sample list (35), and, if so, the next sample minutiae point can be selected (31). If not, the point by point comparison process is terminated and a determination of whether the sample print matches the template print can be performed (40), as more fully described below.

If the minutiae type of the sample point matches the minutiae type of the selected template point, a comparison of geographic location of the points within their respective fingerprints can be performed. This process reduces the likelihood that a minutiae point in the sample print will be incorrectly matched to a minutiae point in the template print that might have similar characteristics but resides in a different location on the fingerprint. In the exemplary embodiment, a geographic range is defined by the predetermined tolerance in both the horizontal (X) direction and the vertical (Y) direction. A comparison can be performed to determine if the sample point and the template point are within the predetermined tolerance in the X direction (34) and a comparison can be performed to determine if the sample point and the template point are within the predetermined tolerance in the Y direction (35). In one embodiment, a pre-sorting process is performed to reduce the amount of comparisons needed for at least one direction. For example, the sample minutiae points can be sorted in ascending order based upon the Y coordinate of each, and then processed in the sorted order. Once the tolerance level for the Y direction has been exceeded, there is no longer a need to perform a check on any remaining points with respect to the Y tolerance. This is because if the points are pre-sorted in ascending order with respect to the Y direction, all remaining points will have a Y coordinate that is larger and thus falls outside of the tolerance level.

If the pixel location of the minutiae point from the sample list fails to reside within the acceptable tolerance for either the X direction or the Y direction, no further evaluation of this sample point is performed. As described above, a check can be performed to determine if additional minutiae points remain in the template image (38). If so, the next minutiae point in the template can be selected (32) and the comparison process is repeated. If not, a check can be performed to determine if additional points remain on the sample list (35), and, if so, the next sample minutiae point can be selected (31). If not, the point by point comparison process is terminated and a determination of whether the sample print matches the template print can be performed (40), as more fully described below.

If the pixel location resides within the geographic parameter, a comparison of the angle criteria is performed to further determine if the sample point is a potential match to the point in the template (36). The angle criteria for the minutiae point from the subject list is compared to the angle criteria associated with the template minutiae to determine if it resides within the predetermined angle tolerance. Points that fall outside of the tolerance are eliminated. Eliminating points that fall outside of the angle tolerance reduces the likelihood of false reading from users who attempt to fool the system using what is referred to as a “tissue paper” attempt to represent a fingerprint. This term applies to using a crumpled piece of paper to create an image that appears to have a large volume of minutiae. However, while the created image might have a sufficient number of minutiae to create some matching point geographically, each minutiae will have an indeterminate angle measurements and would thus be eliminated from consideration. Thus, in a similar manner to that performed for the X and Y directions, if the angle criteria of the minutiae point from the sample list fails to reside within the acceptable angle tolerance from the angle of the template minutiae point, and no further evaluation of this sample point is performed. A check is performed to determine if additional minutiae points remain in the template image (38). If so, the next minutiae point in the template can be selected (32) and the comparison process is repeated. If not, a check is performed to determine if additional points remain on the sample list (35), and, if so, the next sample minutiae point is selected (31). If not, the point by point comparison process is terminated and a determination of whether the sample print matches the template print is performed (40), as more fully described below.

If the sample minutiae is deemed to match the type, x coordinate, y coordinate, and angle, the sample point can be considered to be a potential match to the template point (37). In the exemplary embodiment, the point is stored in a list of potential matches. At this point, a check is performed to determine if additional minutiae points remain in the template image (38). Despite finding a potential matching template point, the remaining minutiae points in the template can be selected (32) and the comparison process can be repeated to determine if other potential matching points exist. If no additional points remain in the template image, a check is performed to determine if additional points remain on the sample list (35), and, if so, the next sample minutiae point is selected (31). If not, the point by point comparison process is terminated and a determination of whether the sample print matches the template print is performed (40), as more fully described below, and the remaining points in the sample list are evaluated.

Once a list of potential matching points has been compiled, a determination of whether the sample print is an actual match to the template print is performed. Because only the pairs of minutiae points identified as potential matches will be evaluated for actual matching, the process is typically terminated at this point if the process for identification of potentially matching pairs yielded a number of potentially matching pairs less than a predetermined threshold (14 of FIG. 1). In such an event, the sample print is deemed not to match the template print (16). If a sufficient number of potentially matching pairs exists, the process to identify actual matches is performed (15). In the exemplary embodiment, if a sufficient number of potentially matching pairs are found to be actual matches (17) using the matching process described below, the sample print is deemed to be a match of the template print (18). If an insufficient number of potentially matching pairs are found to be actual matches using the matching process described below, the sample print is deemed not to be a match of the template print (19).

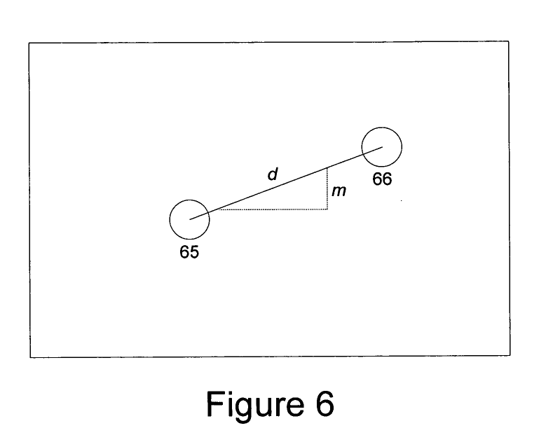

Because the process only involves an evaluation of the pairs identified as potential matches, the memory and processing requirements are typically significantly less than those used with prior minutiae matching techniques. In the exemplary embodiment, the potentially matching pairs are stored by calculating the length and angle of a line connecting the two points. Referring to FIG. 6, a potentially matching pair of minutiae points comprising a sample point 65 and a template point 66 is shown. A line is constructed between the two points. This line is used to determine the values that are indicative of the potentially matching pair. A distance (d) is indicative of the distance between the two points, and a slope (m) is indicative of the direction between the two points. A matrix of potential matches can be built using these criteria (e.g., potential matching pointₙ [SamplePointₙ, TemplatePointₙ, distanceₙ, slopeₙ]).

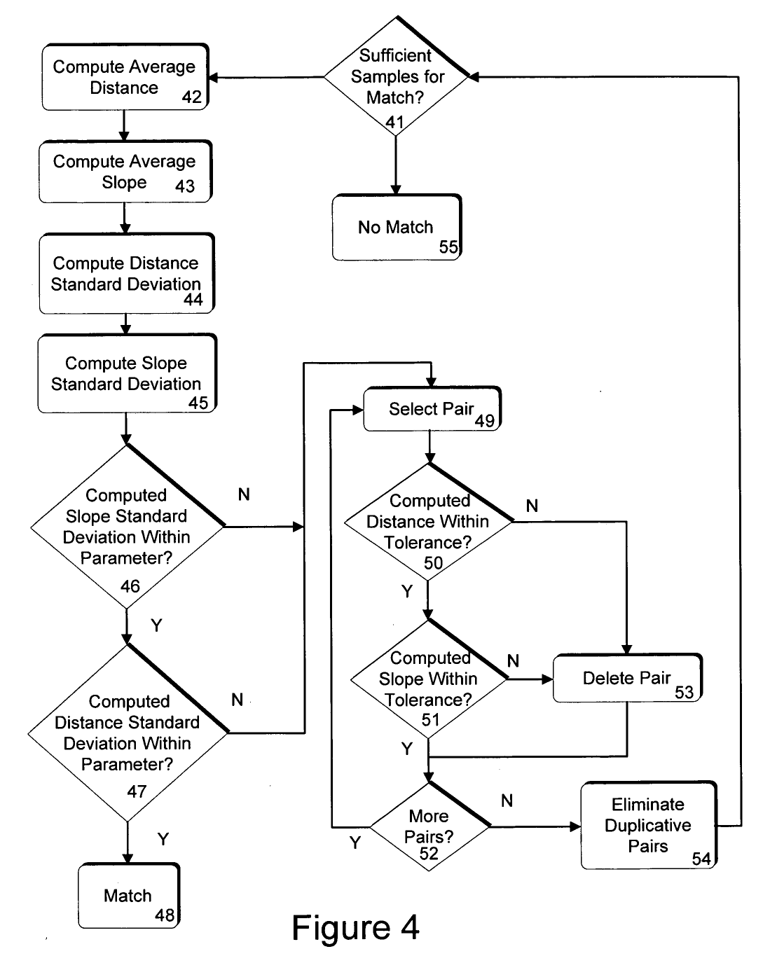

Once all sample points have been evaluated, the list of potential matching points is examined to determine actual matching points. An exemplary process for evaluating the potential matching points is illustrated in the flow chart shown in FIG. 4. The initial step checks to determine if a sufficient number of samples, i.e., potentially matching pairs (41). If a sufficient number of potentially matching pairs does not exist, the sample print is deemed not to match the template print at this point (55). If a sufficient number of potentially matching pairs exists, the evaluation process computes the average distance (42) and average slope (43) of all potential matching points. For each parameter, a standard deviation is computed for the distance measurements (44) and for the slope measurements (45). A comparison is performed for each potentially matching pair as to whether the sample point and the template point are within the predetermined limits. If the computed standard deviations for both the slope and the distance (46, 47) fall within a predetermined parameter, the subject print is deemed to match the template print (48). If, however, this is not the case at this point, the individual potentially matching pairs can be evaluated further.

To evaluate the potentially matching pairs, a pair is selected (49). A determination is made whether the distance parameter is within a predetermined tolerance (e.g., +/−1 standard deviation) from the average distance (50) and whether the slope parameter is within a predetermined tolerance (e.g., +/−1 standard deviation) from the average slope (51). Any pairs that are not within this parameter are eliminated from consideration, i.e., deleted (53). If more pairs exist on the list of potentially matching pairs (52), the next pair is selected and the process is repeated until no additional potentially matching pairs remain.

Additionally, any duplicative pair can be eliminated (54). A duplicative pair is one where a single sample point has been identified as a potential match for two or more template points. In such instances, the pair that has a distance closest to the average distance is saved and all other potential matches for that particular sample point are discarded.

A check is again performed to determine if the remaining number of pairs in the matrix of potentially matching pairs exceeds the predetermined number of points indicative of a sufficient number of points required for a match (41). If there are insufficient points, the sample print is deemed not to match the template print (55). If, however, the number of pairs still exceeds the predetermined number of points needed for a match, the matching evaluation process can be repeated. A second set of average and standard deviation values is calculated (42, 43, 44, 45)) using the remaining potentially matching pairs (using the remaining pairs after the elimination of those pairs that fell outside the first calculated standard deviations and the elimination of duplicative pairs). After calculating the second of average and standard deviation values, a series of additional comparisons can be made to determine if the sample print is a match to the template print. If the second set of standard deviation values for distance (46) and slope (47) are within predetermined levels, the sample print is deemed to be a match to the template print (48). The process can be repeated until the comparison of all potentially matching pairs (46, 47) yields a matching result or until the list of points is reduced to a level below that required to find a match (41).

The predetermined number of samples needed to classify a sample print as a match to a template print can be varied in accordance with the degree of accuracy required for a particular application. For example, the number of samples could be set at twelve. A sample print with twelve minutiae points that match a template print (commonly referred to as a “twelve point match”) would provide a very high level of accuracy for those prints that are deemed to be a match.

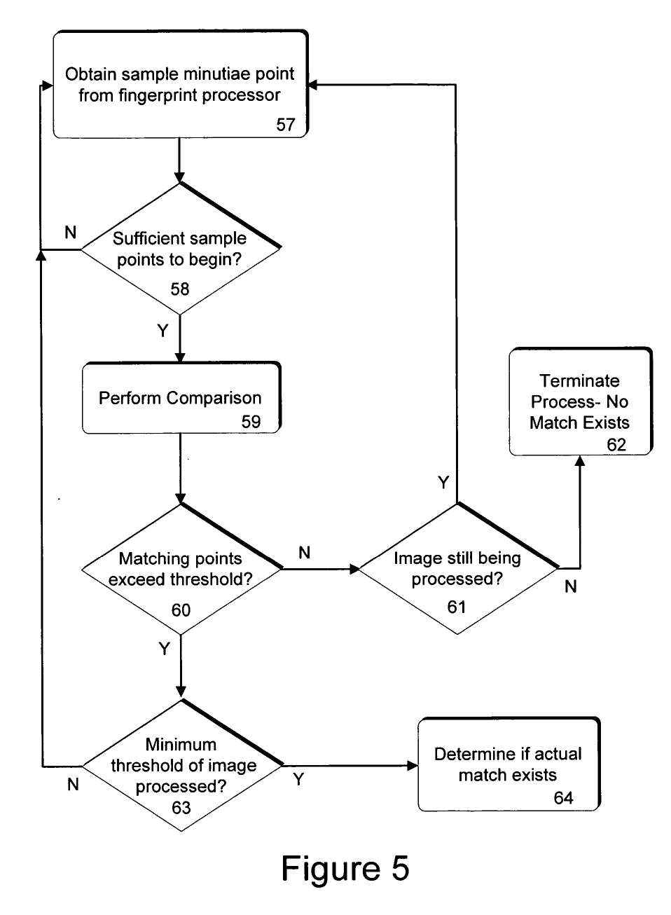

An alternative embodiment of the invention allows for comparing a fingerprint as it is obtained from a swipe sensor. In the embodiment described above and shown in FIG. 1, a sample list minutiae points is built for the sample image and the list is then compared against the template image. In an alternative embodiment, the matching process can be started as soon as a minimum predetermined number of sample points are obtained from the fingerprint processor. Referring to FIG. 5, a sample point is obtained from a fingerprint processor as an image is read (e.g., a finger is swiped past the sensor) (57). Once a minimum number of sample points are obtained from the fingerprint processor and added to the sample list (58), the matching or comparison process as described above with reference to FIGS. 2 and 3 is performed on the sample points in the sample list (59). However, before evaluating the potential matches using the technique described above with reference to FIG. 4, a check is made to determine if the number of potential matches exceeds a predetermined minimum (60). If it does not, a determination is made as to whether the sample image is still being processed by the fingerprint processor (i.e., more points are available) (61). If it is, an additional predetermined amount of points are added to the sample list (57) and the process is repeated. If the fingerprint image is no longer being processed (i.e., no further points are available), the process is terminated at this point and the sample print is indicated not to be a match to the template print (62).

If the determination as to whether the number of potential matches exceeds a predetermined minimum (60) indicates that a sufficient number of potential matches exists, a second check can be made to determine if a predetermined portion of the fingerprint image has been processed by the fingerprint processor (63). For example, in order to maintain a high degree of accuracy in the fingerprint matching process, it could be determined that at least 50% of a print image should be obtained before declaring a match to a template. If the amount of the sample print processed by the fingerprint processor is below the predetermined threshold, an additional point is obtained from the processor as the image continues to be obtained (57) and the process is repeated. If the predetermined threshold for the minimum amount of the sample image desired for adequate matching has been reached, the process of determining actual matching points as described above with reference to FIG. 4 can be performed (64).

Processing minutiae points in accordance with the exemplary embodiments of the invention described herein allows for the amount of memory needed to perform the minutiae matching techniques to be significantly reduced because the points from a potentially matching template are screened to reduce the number of potential matches, thus the actual matching process can be performed only on those points that have been pre-classified as a potentially matching point.

While the embodiment described herein has been described with reference to an image obtained using a swipe sensor, it should be appreciated that other embodiments can utilize pad sensors or other alternative imaging devices. In additions, a variety of modifications to the embodiments described will be apparent to those skilled in the art from the disclosure provided herein. Thus, the present invention may be embodied in other specific forms without departing from the spirit or essential attributes thereof and, accordingly, reference should be made to the appended claims, rather than to the foregoing specification, as indicating the scope of the invention.

What is claimed is:

1. A method for print analysis comprising:
compiling a list of sample minutiae points from a sample image;
assigning a first predetermined set of evaluation characteristics to each sample minutiae point;
performing a first matching process whereby each sample minutiae point in the list of sample minutiae points is compared to a set of points from a template image based upon the first set of evaluation characteristics;
compiling a list of potentially matching pairs, wherein each pair comprises a sample minutiae point and a template minutiae point indicated as potentially matching points based on the first matching process;
performing a second matching process whereby each potentially matching pair is evaluated in accordance to a second set of predetermined evaluation characteristics to determine if the pair is an actual match; and
determining if the sample image matches the template image based upon results of the second matching process.

2. The method as set forth in claim 1, wherein the first set of predetermined evaluation criteria comprises at least one of the following factors: geographic location, minutiae type, or angle of ridge lines within a predetermined distance.

3. The method as set forth in claim 1, wherein the second matching process further comprises:
for each potentially matching pair, computing a distance value equal to the length of a line between the sample minutiae point and the template minutiae point in each pair;
for each potentially matching pair, computing a slope value equal to the slope of the line connecting between the sample minutiae point and the template minutiae point in each pair;
determining if the each potentially matching pair is an actual matching pair based upon the distance value and the slope value.

4. The method as set forth in claim 3, further comprising:
calculating an average distance value from the distance values of each potentially matching pair;
calculating an average slope value from the slope values of each potentially matching pair;
calculating a standard deviation for the average distance value;
calculating a standard deviation for the average slope value; and
determining if the each potentially matching pair is an actual matching pair if the distance value and the slope value for the pair is within a predetermined number of standard deviations from the average distance value and the average slope value, respectively.

5. The method as set forth in claim 4, wherein the predetermined number is one.

6. The method as set forth in claim 4, further comprising:
eliminating each potentially matching pair that is not within the predetermined number of standard deviations from the average distance value and average slope value;
calculating a second standard deviation for the average distance value;
calculating a second standard deviation for the average slope value;
determining if the each potentially matching pair is an actual matching pair if the distance value and the slope value for the pair is within a predetermined number tolerance of the second standard deviation value for the average distance value and the second standard deviation value for the average slope value.

7. The method as set forth in claim 1, wherein the determining step comprises deeming the subject print to be a match to the template print when the number of actual matches exceeds a predetermined number of matches.

8. The method as set forth in claim 7, wherein the predetermined number of matches is twelve.

9. The method as set forth in claim 1, wherein the first and second matching processes are performed while the sample image is being obtained by a fingerprint imaging device.

10. A system for fingerprint analysis comprising:
a processor, the processor containing data representative of a plurality of minutia from a sample print image, wherein the processor is configured to perform the following:
creating a list of sample minutia points from the data;
assigning a first predetermined set of evaluation characteristics to sample minutiae point on the list of sample minutiae points;
performing a first matching process whereby each sample minutiae point in the list of sample minutiae points is compared to a set of points from a template image based upon the first set of evaluation criteria;
compiling a list of potentially matching pairs, wherein each pair comprises a sample minutiae point and a template minutiae point indicated as potentially matching points based on the first matching process;
performing a second matching process whereby each potentially matching pair is evaluated in accordance to a second set of predetermined evaluation characteristics to determine if the pair is an actual match; and
determining if the sample image matches the template image based upon results of the second matching process.

11. The system as set forth in claim 10, wherein the processor is coupled to a fingerprint imaging device.

12. The system as set forth in claim 10, wherein the first set of predetermined evaluation criteria comprises at least one of the following factors: geographic location, minutiae type, or angle of ridge lines within a predetermined distance.

13. The system as set forth in claim 10, wherein the second matching process further comprises:
for each potentially matching pair, computing a distance value equal to the length of a line between the sample minutiae point and the template minutiae point in each pair;
for each potentially matching pair, computing a slope value equal to the slope of the line connecting between the sample minutiae point and the template minutiae point in each pair;
determining if the each potentially matching pair is an actual matching pair based upon the distance value and the slope value.

14. The system as set forth in claim 10, wherein the processor is further configured to perform the following:
calculating an average distance value from the distance values of each potentially matching pair;
calculating an average slope value from the slope values of each potentially matching pair;
calculating a standard deviation for the average distance value;
calculating a standard deviation for the average slope value; and
determining if the each potentially matching pair is an actual matching pair if the distance value and the slope value for the pair is within a predetermined number of standard deviations from the average distance value and the average slope value, respectively.

15. The system as set forth in claim 14, wherein the processor is further configured to perform the following:
eliminating each potentially matching pair that is not within the predetermined number of standard deviations from the average distance value and average slope value;
calculating a second standard deviation for the average distance value;
calculating a second standard deviation for the average slope value; and
determining if the each potentially matching pair is an actual matching pair if the distance value and the slope value for the pair is within a predetermined number tolerance of the second standard deviation value for the average distance value and the second standard deviation value for the average slope value.

16. The system as set forth in claim 10, wherein the determining step comprises deeming the subject print to be a match to the template print when the number of actual matches exceeds a predetermined number of matches.

17. A computer program product comprising a computer useable medium having program logic stored thereon, wherein the program logic comprises machine readable code executable by a computer, wherein the machine readable code comprises instructions for:
compiling a list of sample minutiae points from a sample image;
assigning a first predetermined set of evaluation characteristics to each sample minutiae point;
performing a first matching process whereby each sample minutiae point in the list of sample minutiae points is compared to a set of points from a template image based upon the first set of evaluation characteristics;
compiling a list of potentially matching pairs, wherein each pair comprises a sample minutiae point and a template minutiae point indicated as potentially matching points based on the first matching process;
performing a second matching process whereby each potentially matching pair is evaluated in accordance to a second set of predetermined evaluation characteristics to determine if the pair is an actual match; and
determining if the sample image matches the template image based upon results of the second matching process.

18. The computer program product as set forth in claim 17, wherein the first set of predetermined evaluation criteria comprises at least one of the following factors: geographic location, minutiae type, or angle of ridge lines within a predetermined distance.

19. The computer program product as set forth in claim 17, wherein the instructions for the second matching process further comprises instructions for:
for each potentially matching pair, computing a distance value equal to the length of a line between the sample minutiae point and the template minutiae point in each pair;
for each potentially matching pair, computing a slope value equal to the slope of the line connecting between the sample minutiae point and the template minutiae point in each pair;
determining if the each potentially matching pair is an actual matching pair based upon the distance value and the slope value.

20. The computer program product method as set forth in claim 17, further comprising instructions for:
calculating an average distance value from the distance values of each potentially matching pair;
calculating an average slope value from the slope values of each potentially matching pair;
calculating a standard deviation for the average distance value;
calculating a standard deviation for the average slope value; and
determining if the each potentially matching pair is an actual matching pair if the distance value and the slope value for the pair is within a predetermined number of standard deviations from the average distance value and the average slope value, respectively.
